(19) United States
(12) Patent Application Publication
(10) Pub. No.: US 2020/0262582 A1
(43) Pub. Date: Aug. 20, 2020

(54) DUST-PROOFING STRUCTURE, BINOCULAR SENSOR AND UNMANNED AERIAL VEHICLE

(71) Applicant: SZ DJI TECHNOLOGY CO., LTD., Shenzhen (CN)

(72) Inventors: Jiadi WANG, Shenzhen (CN); Yijun GUAN, Shenzhen (CN)

(21) Appl. No.: 16/863,267

(22) Filed: Apr. 30, 2020

Related U.S. Application Data
(63) Continuation of application No. PCT/CN2017/112808, filed on Nov. 24, 2017.

(51) Int. Cl. B64D 47/08

(52) U.S. Cl. CPC B64D 47/08; B64C 39/024

(57) ABSTRACT

A sensor includes a camera and a dustproof structure. The dustproof structure includes a case accommodating the camera. The case includes a lens hole at a position corresponding to the camera. The dustproof structure further includes an airflow generating device configured to blow airflow to form an airflow barrier between the camera and the lens hole.

### CROSS-REFERENCE TO RELATED APPLICATION

This application is a continuation of International Application No. PCT/CN2017/112808, filed Nov. 24, 2017, the entire content of which is incorporated herein by reference.

### TECHNICAL FIELD

The present disclosure relates to an image capturing device field and, more particularly, to a dust-proofing structure, a binocular sensor, and an unmanned aerial vehicle.

### BACKGROUND

More and more intelligent devices such as unmanned aerial vehicles (UAVs) have been employed for various applications with the continuous development of science and technology.

In existing technologies, a smart device needs to rely on a sensing device such as a vision sensor to detect an external environment when executing a task automatically. A binocular sensor has two cameras arranged at intervals and can obtain a three-dimensional geometric information of a surrounding environment or an object to be detected (e.g., the distance between the smart device and the object) by using a visual difference between the cameras at different positions through a plurality of images, thereby performing a relatively comprehensive and reliable sensor detection. On the other hand, since the smart device may work in a relatively harsh environment, dusts and water droplets in the external environment may contaminate the camera lens glass of the binocular sensor, which adversely affects the sensing detection.

### SUMMARY

In accordance with the disclosure, there is provided a sensor including a camera and a dustproof structure. The dustproof structure includes a case accommodating the camera. The case includes a lens hole at a position corresponding to the camera. The dustproof structure further includes an airflow generating device configured to blow airflow to form an airflow barrier between the camera and the lens hole.

### BRIEF DESCRIPTION OF THE DRAWINGS

FIG. 1 is a schematic diagram of an internal structure of a dustproof structure according to one embodiment of the present disclosure.

FIG. 2 is a schematic structural diagram of a dustproof structure according to one embodiment of the present disclosure.

FIG. 3 is a schematic cross-sectional view of a dustproof structure according to one embodiment of the present disclosure.

FIG. 4 is a schematic structural diagram of a binocular sensor according to another embodiment of the present disclosure.

### REFERENCE NUMERALS

1—Case
2—Airflow generating device
10—Camera
11—Lens hole
12—First accommodation cavity
13—Second accommodation cavity
14—Isolation board
15—Shield
16—Moving assembly
20—Electrical component
21—Airflow outlet
22—Fan
121—First space
122—Second space
131—Airflow inlet
132—Filter
141—Light through hole
151—Through hole
161—Driving motor
162—Rocker arm
100—Dustproof structure
200—Binocular sensor

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

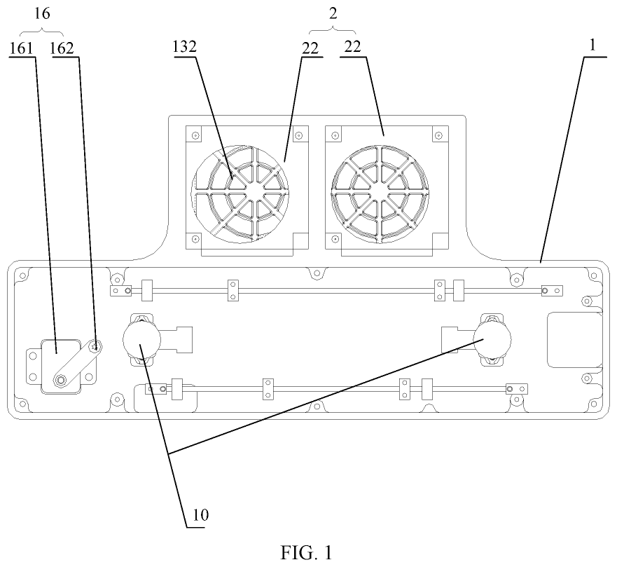

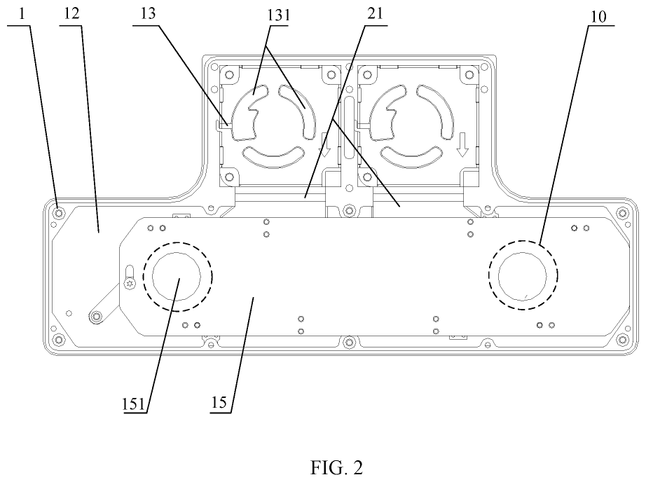

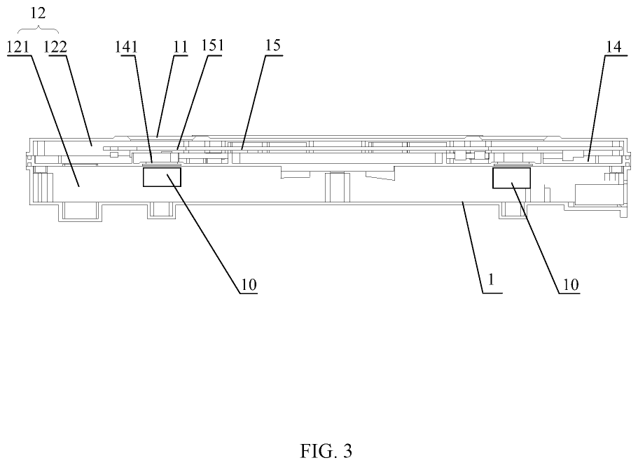

FIG. 1 is a schematic diagram of an internal structure of a dustproof structure according to one embodiment of the present disclosure. FIG. 2 is a schematic structural diagram of a dustproof structure according to one embodiment of the present disclosure. FIG. 3 is a schematic cross-sectional view of a dustproof structure according to one embodiment of the present disclosure. As shown in FIGS. 1-3, the dustproof structure provided in this embodiment includes a case 1 for accommodating at least one camera 10 and an airflow generating device 2. For each of the at least one camera 10, the case 1 is provided with a lens hole 11 at a position corresponding to that camera 10. The airflow generating device 2 is configured to blow airflow to the camera 10 to form an airflow barrier between the camera 10 and the lens hole 11.

Specifically, when a camera or other optical equipment is working, a lens of the camera needs to be kept clean and transparent, and the surface is not contaminated with dust or other impurities to ensure an imaging quality of the camera. On the other hand, when a smart device e.g., a UAV carrying cameras, works outdoors or in other harsh environments, there may be flying dust or other impurities in the environment that can easily contaminate the surface of the camera lens and even enter inside the camera, which can affect the imaging quality of the camera and even interfere with the normal operation of the camera. A dustproof structure as in this embodiment can be arranged outside the camera to prevent dust and other impurities from affecting the camera.

The dustproof structure includes a case 1 for accommodating the camera 10. The case 1 is surrounded on the outside of the camera 10 to perform a protection, so that external dust, liquid droplets or other impurities can be blocked from entering the case 1 and the camera 10 inside the case 1 is not affected by impurities.

In some embodiments, the number of the cameras 10 can be one or more, and when there are a plurality of cameras 10, the plurality of cameras 10 can operate together. For example, the plurality of cameras 10 can constitute a binocular sensor capable of detecting three-dimensional geometric information. The case 1 in the dustproof structure can also accommodate a plurality of cameras 10 at the same time, so as to achieve dustproof for the plurality of cameras 10 together.

Since the camera 10 needs to collect and detect images through visible light, the case 1 does not completely shield the camera 10, but provides a lens hole 11 at a position in front of the lens of the camera 10. External light can enter the lens of the camera 10 through the lens hole 11 so that the camera 10 can collect image of the outside, and hence a normal operation of the camera 10 can be ensured.

Since the camera 10 is exposed through the lens hole 11, in order to prevent external dust and impurities from entering the case 1 through the lens hole 11 and contaminating the lens of the camera 10, the dustproof structure also includes an airflow generating device 2 that can blow airflow to the camera 10. The airflow passes through the area in front of the lens of the camera 10 and form an air curtain between the lens of the camera 10 and the lens hole 11 facing the camera 10. After external dust or small liquid droplets enter the case from the lens hole 11, when encountering the air curtain, they can be blown to the side of the camera 10 under the force of the airflow and cannot fall onto the surface of the lens, thereby achieving an isolation between the camera lens and external impurities. In addition, the air blown to the camera 10 can also implement a cleaning function, i.e., blowing away the dust, liquid droplets, and other impurities that have been attached on the surface of the lens of the camera 10, keeping the surface of the lens clean and tidy.

Since the airflow generating device 2 blows airflow toward the camera 10 and forms an air curtain for the isolation between the camera 10 and the lens hole 11 of the case 1, the airflow mainly flows inside the case 1 and the formed air curtain is also located inside the case 1. On the other hand, the internal space of the case 1 is limited, leading to a relatively strong airflow from the airflow generating device 2 and hence a good performance of blowing and isolating dust and other impurities. At the same time, the airflow outlet 21 of the airflow generating device 2 can be hidden inside the case 1 and is not easily damaged by an external force or blocked by an external dust, and the appearance of the dustproof structure is relatively simple.

In some embodiments, an airflow outlet 21 of an airflow generating device 2 can be arranged inside the case 1 and located at the lateral front of the camera 10. The airflow outlet 21 of the airflow generating device 2 does not block the front of the camera 10, and the airflow blown by the airflow generating device 2 can flow from the side to the front of the camera 10, thereby forming an air curtain in front of the camera 10 to isolate external dust and impurities.

Further, the airflow outlet 21 of the airflow generating device 2 can be directed to the camera 10, so that the airflow blown by the airflow generating device 2 flows along the surface of the lens of the camera 10. Specifically, since the airflow outlet 21 of the airflow generating device 2 is located at the lateral front of the camera 10, when the airflow outlet 21 is directed to the camera 10, the airflow will flow out from one side of the camera 10, pass through the surface of the camera 10, and flow to the other side of the camera 10. The surface of the lens of the camera 10 is always covered by the airflow blown out by the airflow generating device 2, and the dust and impurities can be blocked by the airflow and cannot fall on the lens. At the same time, the airflow passing the surface of the lens of the camera 10 can also clean the lens.

A first accommodation cavity 12 for accommodating the camera 10 is formed in the case 1 to allow the camera 10 to be housed in the case 1 of the dustproof structure. Specifically, the case 1 can directly function as the cavity wall of the first accommodation cavity 12, and when there are a plurality of cameras 10, all the plurality of cameras 10 can be accommodated in the first accommodation cavity 12. The electrical components connected to the camera 10 can also be located in the first accommodation cavity 12.

The airflow generating device 2 can have a plurality of different positions relative to the case 1. In some embodiments, the airflow generating device 2 can be located inside the case 1 like the camera 10, in which the entire airflow generating device 2 is located in the case 1 of the dustproof structure so as to be protected by the case 1 from being affected by external dust or impurities, or being damaged by an external force. In some embodiments, the airflow generating device 2 can also be located outside the case 1, and the airflow generating device 2 can be easily disassembled or replaced.

In some embodiments, when the airflow generating device 2 is located inside the case 1, an independent cavity can be formed inside the case 1 and the airflow generating device 2 can be set in the independent cavity. Specifically, a second accommodation cavity 13 can be formed in the case for accommodating the airflow generating device 2. The second accommodation cavity 13 is in communication with the first accommodation cavity 12, and the airflow outlet 21 is arranged at the connection between the first accommodation cavity 12 and the second accommodation cavity 13.

In this embodiment, the airflow generating device 2 is arranged in the second accommodation cavity 13 that is independent from the first accommodation cavity 12. A better isolation can be achieved between the airflow generating device 2 and the camera 10 during their operations, preventing normal operation of the camera 10 from being interfered by vibration and heat generated by the operation of the airflow generating device 2. The communication between the second accommodation cavity 13 and the first accommodation cavity 12 makes it possible for the airflow generating device 2 to provide airflow into the first accommodation cavity 12 through the airflow outlet.

In some embodiments, the second accommodation cavity 13 can be located above the first accommodation cavity, in order for the airflow blown by the airflow generating device 2 to flow normally in the case 1. In this embodiment, the airflow outlet of the airflow generating device 2 is also located above the first accommodation cavity 12, and the airflow can be blown out from above, and an isolation air curtain can be formed in front of the camera 10. The blowing direction of the airflow is consistent with the gravity direction of the airflow itself, the airflow can achieve normal convection from top to bottom in the case 1 under the effect from the gravity, ensuring that the airflow blown by the airflow generating device 2 has sufficient speed and intensity.

In order to blow the airflow to the front of the camera 10 to form an air curtain that can isolate dust and impurities, the airflow generating device 2 can generate airflow through a variety of different principles and structures. Embodiments of various possible structures and settings of the airflow generating device 2 are described below in detail.

In one embodiment, the airflow generating device 2 includes a fan 22 with its air outlet side facing the camera 10. The air can be driven to move toward the air outlet side of the fan 22 through the rotation of the blades of the fan 22, and form an air flow on the air outlet side of the fan 22. In this embodiment, the air outlet side of the fan 22 is set toward the camera 10, and the airflow can be blown to the camera 10, so that an air curtain can be formed in front of the camera 10 by the airflow. An airflow can be generated as long as the blades of the fan 22 are driven to rotate. The structure of the airflow generating device 2 is relatively simple and convenient to maintain.

The fan 22 generates an airflow by driving air to move. In order to provide fresh air for driving the fan 22, an air inlet 131 is formed at the cavity wall of the second accommodation cavity 13, and the air inlet 131 is arranged corresponding to an air inlet side of the fan 22. When the blades of the fan 131 rotate, external air can be drawn into the case 1 through the air inlet 131, and a relatively strong airflow can be formed and blown out by the blades pressing and driving the air. The air inlet 131 can be opened on the cavity wall of the second accommodation cavity 13, and there may be a plurality of air inlets 131 to ensure that the air intake side of the fan 22 has sufficient air intake efficiency.

A filter 132 is arranged at the air inlet 131 to avoid outside dust and impurities being sucked into the case through the air inlet. The filter 132 generally has fine mesh or filter holes, which can filter the air before the fan 22 draws in air, and blocks impurities in the air outside the filter 132, to ensure the air sucked in by the fan 22 is clean.

In some embodiments, the filter 132 can include a single-layer filter or a multi-layer filter to ensure the filtering performance of the intake air.

In some embodiments, the filter 132 can be fixed on the wall of the case 1, or can be connected to the case 1 in a detachable manner to be cleaned or replaced when there is a lot of dust on the filter 132.

In some embodiments, the number of fans 22 can be at least one. A plurality of fans can be arranged in the second accommodation cavity 13 to provide an airflow with sufficient strength simultaneously, leading to a good dustproof capability of the dustproof structure.

In some embodiments where there are a plurality of camera 10, in order to provide airflow to each camera 10, the number of the fan 22 can be the same as the number of the camera 10, and the fans 22 and the cameras 10 are arranged one-to-one correspondingly. Each camera 10 has a corresponding fan to provide an airflow for dustproof, the camera 10 can be effectively protected, and the dustproof structure can have a relatively good dustproof performance.

When there are a plurality of fans 22, the second accommodation cavity 13 in the case 1 can also have a variety of different structures to install the fans 22 properly. For example, as shown in FIG. 1 and FIG. 2, in one embodiment, the second accommodation cavity 13 has one single cavity with a plurality of fans 13 in it. In this embodiment, the structure of the case is relatively simple, and the plurality of fans can jointly blow out the airflow to improve the intensity of the airflow.

In another embodiment, a second accommodation cavity 13 can have a plurality of cavities and the plurality of fans 22 are respectively arranged in different cavities of the second accommodation cavity 13. In this embodiment, the fans 22 are arranged independently and do not cause a mutual interference of the airflow during operation, and hence each fan 22 can have relatively high airflow generation efficiency.

The fan 22 can have different types and structures, e.g., a centrifugal fan or an axial fan. The air outlet side of the centrifugal fan is located in the radial direction of the fan, and the air outlet side of the axial flow fan is along the axial direction of the fan. A suitable fan type can be selected according to the shape of the second accommodation cavity 13 of the case 1 and the size of the internal space, to achieve a relatively small case volume and relatively high airflow generation efficiency.

In another embodiment, an airflow generating device 2 can be a relatively close and independent device and include a compressed air source (not shown in the diagram). The air outlet of the compressed air source is located on the lateral front of the camera 10, from where the compressed air source can blow the compressed air out, forming an air curtain in front of the camera 10. The compressed air source relies on the pressure difference between the compressed air and the outside air to blow the compressed air out, leading to a large strength of the formed airflow and a better dustproof performance of the dustproof structure.

Specifically, a compressed air source can be an air pump or a compressed air tank, etc. An air pump can inhale air from the outside, compress the air, and blow the compressed air out through the air outlet to form an airflow for protecting the lens of the camera 10. A compressed air tank itself can store high pressure compressed air. When the air outlet of the compressed air tank is opened, the compressed air can be blown out from the air outlet and form an airflow that isolates the lens from the outside. The interior of the compressed air tank can be completely isolated from the outside and blow out an airflow only using the compressed air stored inside the tank. The air pump can also use a relatively small air inlet or an air pipe to implement air intake. In this embodiment, when the compressed air source is an air pump, or a compressed air tank, configuring a large air inlet on the case 1 is not needed, and the airflow generating device 2 is not easily interfered by the external environment of the dustproof structure.

A shielding structure can be added inside the case to improve the shielding effect of the case 1 on the camera 10 and other electrical components. In some embodiments, an isolation plate 14 is arranged in front of the camera 10 in the first accommodation cavity 12, and divide the first accommodation cavity 12 into a first space 121 where the camera 10 is held and a second space 122 in front of the camera 10. The airflow outlet 21 of the airflow generating device 2 is connected with the second space 122. A light through hole 141 is formed on the isolation plate 14 at a position corresponding to the camera 10.

Specifically, the isolation plate 14 can be placed horizontally in the first accommodation cavity 12, with the plate surface direction of the isolation plate 14 facing the front of the camera 10 and the edge of the isolation plate 14 being close to or in contact with the cavity wall of the first accommodation cavity 12. That is, the isolation plate 14 divides the first accommodation cavity 12 into two different spaces. The camera 10 and other electrical components are held in a first space 121 of the two spaces, and a normal visual signal acquisition of the camera 10 can be ensured through the light through hole 141. A second space 122 separated from the first space 121 is formed in front of the camera 10 and in communication with the airflow outlet 21 of the airflow generating device 2. When the air flow is blown out, the formed air curtain can be limited to the range of the second space 122. In this embodiment, the second space 122 is formed by the first accommodation cavity 12 being divided by the isolation plate 14, and hence has a relatively small volume. The airflow blown in is concentrated in the second space 122, which can maintain a high airflow intensity and result in a better dustproof performance of the formed air curtain.

Since a light through hole 141 is opened on the isolation plate 14, when the airflow generating device 2 is not operating or dusk particles are large, impurities such as dust may still pass through the lens hole 11 on the case 1 and the light through hole 141 on the isolation plate 14, and fall on the surface of the lens of the camera 10. In order to further isolate the dust, the dustproof structure can further include a movable shielding plate 15 that is arranged in the second space 122 and used to shield the front of the camera 10 or move away from the shielding position.

Specifically, the shielding plate 15 can move. When the camera 10 is not operating or an external environment is too harsh, the shielding plate 15 can be moved to a position at which the shielding plate 15 can block in front of the camera 10. The light through hole 141 on the isolation plate 14 is covered by the shielding plate 15, and the external dust cannot fall on the lens of the camera 10 through the light through hole 141. On the other hand, when the camera 10 needs to operate, the shielding plate 15 can be removed from the shielding position, and the external light can enter the lens of the camera 10 through the light through hole 141 normally.

Specifically, the shielding plate 15 is arranged in the second space 122 to avoid an interfere with the camera 10 and other components when the shielding plate 15 is moving. In addition, the airflow outlet 21 of the airflow generating device 2 is in communication with the second space 122, and the airflow generating device 2 can also blow out the airflow to the shielding plate 15 to clean the dust and impurities attached to the shielding plate 15 during shielding.

In some embodiments, the dustproof structure further includes a moving assembly 16 that is connected to the shielding plate 15 to drive the shielding plate 15 to move in the case 1. The moving assembly 16 can be controlled manually or automatically by a power device, e.g., a motor. The power device enables an automatic device to move the shielding plate 15 to or from the shielding position according to the working environment.

In some embodiments, when a power device is configured to control the movement of the shielding plate 15, the moving assembly 16 includes a driving motor 161 and a rocker arm 162. A first end of the rocker arm 162 is connected to the shielding plate 15, and a second end of the rocker arm 162 is connected to the output shaft of the driving motor 161 and can be rotated around the first end of the rocker arm 162 under the driving of the driving motor 161 to move the shielding plate 15. In one embodiment, the rocker arm 162 rotates around the output shaft of the drive motor 161, and the second end of the rocker arm 162 can be connected to the shielding plate 15 to drive the shielding plate 15 to move. Specifically, the shielding plate 15 can be hinged with the cavity wall of the first accommodation cavity 12 and rotated by the rocker arm 162 around the hinge axis to shield or clear the light through hole 141. In another embodiment, the shielding plate 15 can also be moved to different positions translationally by the rocker arm 162 to shield or clear the through hole 141.

In some embodiment, the dustproof case 1 surrounds the camera 10, and the shielding plate 15 is arranged in the second space 122 in front of the camera 10. In order to reduce the size of the dustproof structure along the axial direction of the camera 10, the second space 122 can have a smallest size in this direction. In one embodiment, the shielding plate 15 and the isolation plate 14 are arranged in parallel and the moving direction of the shielding plate 15 is also parallel to the plate surface of the shielding plate 15, to reduce the size of the second space 122. As such, the shielding plate 15 always moves in the direction of its own plate surface. Because the plate surface of the isolation plate 14 faces the front of the camera 10, the shielding plate 15 being arranged parallel to the isolation plate 14 can result in a minimum size in the axial direction of the camera 10. When the shielding plate 15 moves, the dimension in the axial direction of the camera 10 remains substantially unchanged. As such, when the shielding plate 15 moves, the space occupied by the shielding plate 15 in the axial direction of the camera 10 is minimal, and hence the size of the second space 122 in the axial direction of the camera 10 can be significantly reduced, leading to a reduced overall size of the dustproof structure. In some embodiments, a guide is further provided in the second space 122 for guiding to ensure the translation direction of the shielding plate 15.

Specifically, in some embodiments, a through hole 151 can be formed in the shielding plate 15. When the shielding plate 15 is shielding in front of the camera 10, the positions of the through hole 151 and the light through hole 141 do not overlap. When the shielding plate 15 is moved away from the shielding position, the positions of the through hole 151 and the light through hole 141 are aligned with each other. The through hole 151 on the shielding plate 15 corresponding to the light through hole 141 makes it possible to align or stagger the through hole 151 and the light through hole 141 on the isolation plate 14 by only moving the shielding plate 15 by a small distance, instead of removing the entire shielding plate 15 from the front of the isolation plate 14. As such, the movement amount of the shielding plate 15 is relatively small, and the overall size of the dustproof structure can be reduced.

In the embodiments of the present disclosure, the through hole 151 on the shielding plate 15, the light through hole 141 on the isolation plate 14, and the lens hole 11 on the case 1 all have apertures matching the camera 10 to avoid obstructing the field of view of the camera 10 and limiting the angle of view of the camera 10, and hence ensure that the camera 10 can have a good field of view when the shielding plate 15 is removed.

In some embodiments, the shielding plate 15 and the isolation plate 14 may not be in direct contact with, but may be spaced apart from each other. The edge of the shielding plate 15 is directly facing the airflow outlet 21 and the airflow blown from the airflow generating device 2 can flow through the inner and outer surfaces of the shielding plate 15 respectively. The movement of the shielding plate 15 is not blocked and interfered by the isolation plate 14 and the movement process is relatively smooth. In addition, the airflow generating device 2 can use airflow to form air curtains on the inner surface facing the camera 10 and the outer surface away from the camera 10 of the shielding plate 15, respectively, and hence ensure the inner and outer surfaces of the shielding plate 15 are not contaminated by dust and the surface of the lens of the camera 10 is not polluted when the shielding plate 15 is shielding the camera 10.

In this embodiment, there is a gap between the shielding plate 15 and the isolation plate 14. When the shielding plate 15 is in the shielding position, a sealing component (not shown in the diagram) is further arranged between the shielding plate 15 and the isolation plate 14 to prevent outside dust from entering the first space 121 through the gap between the shielding plate 15 and the isolation plate 14. The sealing component can make up the gap between the shielding plate 15 and the isolation plate 14, and prevent outside dust and other impurities from entering through the gap. In one embodiment, the sealing component can be a sealing ring, etc., that can be formed along the circumferential direction of the shielding plate 15 or the isolation plate 14 and surround the light through hole 141 therein. When the shielding plate 15 shields the light through hole 141, both sides of the isolation plate 14 are completely isolated, and dust cannot pass through. In some embodiments, the sealing component can be made of rubber, silicone, or another material with certain elasticity to ensure its tightness.

In this embodiment, the dustproof structure includes a case for accommodating at least one camera, and a lens hole is formed on the case corresponding to each camera. The dustproof structure further includes an airflow generating device that is used to blow airflow to the camera to form an airflow barrier between the camera and the lens hole. The dustproof structure can form an air curtain between the lens of the camera and the lens hole facing the camera by blowing airflow to the camera, thereby achieving the isolation between the camera lens and external impurities and keeping the surface of the lens clean and tidy.

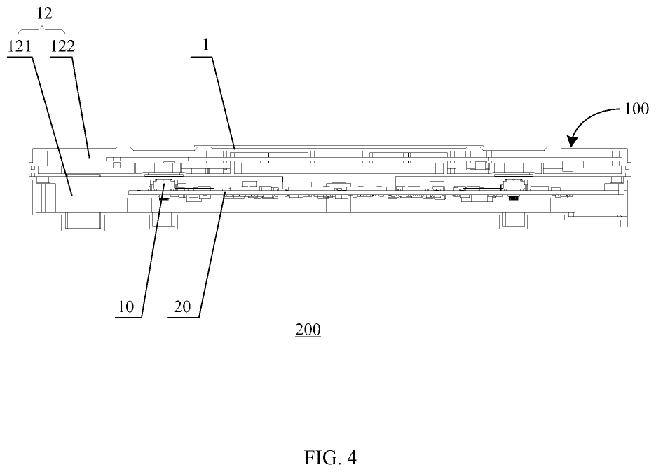

FIG. 4 is a schematic structural diagram of a binocular sensor 200 according to another embodiment of the present disclosure. As shown in FIG. 4, the binocular sensor 200 includes a binocular camera and a dustproof structure 100. The binocular camera includes left and right cameras 10 that are both arranged in the dustproof structure 100. Two lens holes are opened in the dustproof structure 100 and arranged one-to-one with the left and right cameras 10. The specific structure, function, and working principle of the dustproof structure 100 have been described in detail above and are omitted here.

The binocular sensor 200 can respectively photograph and detect an object through the left and right cameras 10 arranged at a certain distance. The images captured by the two cameras 10 can be comprehensively processed according to the distance and the angle different between the two cameras 10, hence a spatial parameter e.g., a three-dimensional shape of the captured object can be obtained to accurately judge the spatial shape or distance of the object. The surface of the lens needs to be kept clean when the camera 10 in the binocular sensor is capturing. The cameras 10 of the binocular sensor are all formed in the dustproof structure 100, and the airflow generating device in the dustproof structure 100 is used to blow out the airflow, thereby forming a blocking air curtain that can isolate external dust and impurities. When the binocular sensor 200 operates, the surface of the lens of the cameras 10 can be always kept clean, which can provide better captured image quality.

In some embodiments, the binocular sensor 200 further includes an electrical component 20 electrically connected to the camera 10 to process the image captured by the camera 10 or control image capturing of the camera 10. The case 1 includes a first accommodation cavity 12 for accommodating the camera 10, and the first accommodation cavity 12 is divided into a first space 121 in which the camera 10 is held and a second space 122 in front of the camera 10. The electrical component 20 is placed in the first space 121 together with the camera 10. The second space 122 located in front of the camera 10 can be used to form a blocking air curtain for the airflow, so that the electrical component 20 and the camera 10 can be protected by the airflow isolation, and will not operate abnormally due to external dust or liquid droplets. In some embodiments, the electrical component 20 can include a printed circuit board (PCB), or another commonly used electrical component.

In this embodiment, a binocular sensor includes a binocular camera and a dustproof structure. The binocular camera includes left and right cameras that are both arranged in the dustproof structure. Two lens holes are opened in the dustproof structure and arranged one-to-one with the left and right cameras. The dustproof structure includes a case for accommodating at least one camera, and a lens hole is formed on the case corresponding to each camera. The dustproof structure further includes an airflow generating device that is used to blow airflow to the camera to form an airflow barrier between the camera and the lens hole. The dustproof structure can form an air curtain between the lens of the camera and the lens hole facing the camera by blowing airflow to the camera, thereby achieving the isolation between the camera lens and external impurities and keeping the surface of the lens clean and tidy, and hence the imaging quality and normal operation of the binocular sensor can be effectively ensured.

The disclosure also provides an unmanned aerial vehicle (UAV) including a UAV body and a binocular sensor, and the binocular sensor is arranged at the UAV body. The specific structure, function, and working principle of the binocular sensor have been described in detail above and are omitted here.

In some embodiments, a UAV can execute operations such as seed and pesticide spraying. When the UAV is spraying seeds or pesticides, the binocular sensor in the UAV is provided with a dustproof structure described in above embodiments, which can effectively avoid external dust or water droplets contamination on the surface of the lens of the binocular sensor, resulting in a good dustproof performance.

In the UAV in this embodiment, the binocular sensor can be arranged at a position such as the front of the UAV body, and there is no structural obstruction in front of the binocular sensor, so that the binocular sensor can have a good visual field.

In this embodiment, a UAV includes a UAV body and a binocular sensor, and the binocular sensor is arranged at the UAV body. The dustproof structure of the binocular sensor includes a case for accommodating at least one camera, and a lens hole is formed on the case corresponding to each camera. The dustproof structure further includes an airflow generating device that is used to blow airflow to the camera to form an airflow barrier between the camera and the lens hole. The dustproof structure can form an air curtain between the lens of the camera and the lens hole facing the camera by blowing airflow to the camera, thereby achieving the isolation between the camera lens and external impurities and keeping the surface of the lens clean and tidy, and hence the imaging quality of the binocular sensor of the UAV and the normal and effective operation of the UAV can be effectively ensured.

The present disclosure has been described with the above embodiments, but the technical scope of the present disclosure is not limited to the scope described in the above embodiments. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the claims.

What is claimed is:

1. A sensor comprising:
a camera; and
a dustproof structure including:
a case accommodating the camera, the case including a lens hole at a position corresponding to the camera; and
an airflow generating device configured to blow airflow to form an airflow barrier between the camera and the lens hole.

2. The sensor of claim 1, wherein an airflow outlet of the airflow generating device is arranged inside the case and located at lateral front of the camera.

3. The sensor of claim 2, wherein the airflow outlet of the airflow generating device is directed towards the camera.

4. The sensor of claim 1, wherein the case includes an accommodation cavity accommodating the camera.

5. The sensor of claim 4, wherein the airflow generating device is located inside the case.

6. The sensor of claim 5, wherein:
the accommodation cavity is a first accommodation cavity;
the case further includes a second accommodation cavity in communication with the first accommodation cavity, the second accommodation cavity accommodating the airflow generating device; and
the airflow outlet is arranged at a connection position between the first accommodation cavity and the second accommodation cavity.

7. The sensor of claim 6, wherein the second accommodation cavity is located above the first accommodation cavity.

8. The sensor of claim 4, wherein:
the dustproof structure further includes an isolation plate arranged in the accommodation cavity and in front of the camera;
the isolation plate divides the accommodation cavity into a first space accommodating the camera and a second space in front of the camera;
the airflow outlet of the airflow generating device is in communication with the second space; and
a light through hole is formed at the isolation plate at a position corresponding to the camera.

9. The sensor of claim 8, wherein the dustproof structure further includes a movable shielding plate in the second space, the shielding plate being configured to be moved to a shielding position to shield a front of the camera or be moved away from the shielding position.

10. The sensor of claim 9, wherein the dustproof structure further includes a moving assembly connected to the shielding plate and configured to drive the shielding plate to move.

11. The sensor of claim 10, wherein the moving assembly includes:
a driving motor; and
a rocker arm, a first end of the rocker arm being connected to the shielding plate, and a second end of the rocker arm being connected to an output shaft of the driving motor and is configured to be driven by the driving motor to rotate around the first end of the rocker arm to move the shielding plate.

12. The sensor of claim 9, wherein:
the shielding plate and the isolation plate are parallel to each other; and
a moving direction of the shielding plate is parallel to a plate surface of the shielding plate.

13. The sensor of claim 12, wherein the shielding plate includes a through hole that is staggered from the light through hole when the shielding plate shields in front of the camera and is aligned with the light through hole when the shielding plate is removed away from the shielding position.

14. The sensor of claim 9, wherein:
the shielding plate is spaced apart from the isolation plate; and
an edge of the shielding plate directly faces the airflow outlet.

15. The sensor of claim 9, wherein the dustproof structure further includes a sealing component between the shielding plate and the isolation plate.

16. The sensor of claim 1, wherein the airflow generating device includes a fan, an air outlet side of the fan facing the camera.

17. The sensor of claim 16, wherein:
the airflow generating device is accommodated in an accommodation cavity of the case; and
an air inlet is formed at a cavity wall of the accommodation cavity, the air inlet being arranged facing an air inlet side of the fan.

18. The sensor of claim 16, wherein the fan includes a centrifugal fan or an axial fan.

19. The sensor of claim 1, wherein the airflow generating device including a compressed air source, an air outlet of the compressed air source being located at lateral front of the camera.

20. The sensor of claim 1, wherein:
the sensor is a binocular sensor including a binocular camera;
the camera is one a left camera of the binocular camera, the lens hole is a first lens hole;
the case further accommodates a right camera of the binocular camera and includes a second lens hole at a position corresponding to the right camera; and
the airflow generating device is further configured to blow airflow to form an airflow barrier between the right camera and the second lens hole.
